(19) United States
(12) Patent Application Publication
(10) Pub. No.: US 2009/0304170 A1
(43) Pub. Date: Dec. 10, 2009

(54) DIRECT DIAL TO VOICE MAIL

(76) Inventor: Sonny R. Bettis, Lawrenceville, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/133,996

(22) Filed: Jun. 5, 2008

(51) Int. Cl. H04M 3/42

(52) U.S. Cl. 379/207.11

(57) ABSTRACT

A calling party can by-pass voice mail menu structures and disturbing of a called party by directly dialing into the called party's voice mail. The calling party dials a special code, such as the digit 2, in conjunction with dialing the called party's telephone number. The telephone network detects the call as being a special call by detecting the special code. In response, the calling party is sent directly to the called party's voice mail without ever ringing the called party's access device and without requiring the calling party to make menu selections for routing the call.

### BACKGROUND

The mobile or cellular telephone has become so common place that those who have chosen to simply not have one are usually met by a raised eyebrow. The market has expanded to provide cellular products for virtually all types of users. We have MP3 players and web browsers integrated with cellular telephones on one end of the spectrum, and we have disposable cellular telephones on the other end of the spectrum. With such a proliferation of cellular telephones, we have really moved towards being a “connected” world.

One of the outcomes of having such connectivity is the casualty of voice mail. The fact that a person can typically be contacted at any time has greatly reduced the need and the use of voice mail. Of course, voice mail is still available for the call recipient's convenience but, often times, the feature goes unused as callers simply hang up to try later or revert to sending a text message instead.

Another outcome of such connectivity is the embarrassment of the untimely telephone call. Almost everyone has experienced being the recipient of an untimely telephone call that results in an custom ring tone being blasted out at an embarrassing moment. These calls have a tendency to arrive during an important meeting, sitting in church, attending or being in a wedding, the middle of a movie, etc. Sure, you could have avoided it if only you had remembered to turn your ringer off! But, as everyone turns to look at you as you frantically search for the button to “dump” the call, such recollection is not so helpful. Dumping a call is a colloquial term for hitting the “end” or “cancel” button in response to an incoming call and thereby forcing the calling party to voice mail.

Well, for each such call there is always another party on the other end that can be equally uncomfortable. You can easily detect when you have made an inopportune call by the classic, softly whispered “hello” accompanied by the rustling sound of a person rapidly exiting an uncomfortable situation. You respond by asking “did I catch you at a bad time”? Other classic lines include “did I wake you up?”, “oh, I forgot, your at the wedding”, “are you still in that meeting?” etc. No one really wants to be “that caller”.

But voice mail is and remains a valuable commodity in the industry. As most are aware, emails and text messages, although they can be quite convenient techniques to communicate, can often be misinterpreted due to a lack of expression that can be attained by leaving a voice message. Even with the use of the most sophisticated emoticons, email and text messages can be misinterpreted. Thus, having the ability to actually leave a voice message remains as a viable communication means. However, unlike text messages and emails, to leave a voice message for a called party, the calling party must run the risk of interrupting the called party at an inopportune time. In addition, there may be times when a calling party does not have time to actually converse with a called party and simply wants to leave them a voice message. But, the calling party runs the risk that the called party will actually answer.

What is needed in the art is a technique for a calling party to directly call a person's voice mail or to be able to directly access a person's voice mail to leave a message. Although there are some services that provide a related functionality, this functionality is generally limited to either having to dial a special number to access a voice mail system and then enter a particular extension or subscriber number, or the functionality is limited within the extensions of a PBX. Thus, there is a need in the art for a technique for a calling party to be able to directly access and leave a message for a called party by using voice mail.

### BRIEF SUMMARY

An embodiment of the present invention provides direct dialing access for an alternate destination of a called party when a calling party dials the called party's telephone number along with a special calling code. In operation, a dialed sequence associated with a call setup request is received from a calling party device. The dialed sequence is parsed in an effort to determine if the call should be handled as a normal call or, if the call is to be subjected to direct access to an alternate destination. In one embodiment, the dialed sequence includes a standard 7 digit or 10 digit telephone number and either a dialing prefix or suffix as a special calling code. If the dialed sequence includes such a special calling code, the calling party can be connected with an alternate destination that is selected based on the value of the special calling code and the standard telephone number. For instance, if the called party has voice mail, the calling party can automatically be connected to voice mail without having to ring the receiving device of the called party.

Advantageously, this embodiment of the invention enables a calling party to access a called party's voice mail for the purpose of leaving a message without requiring any additional information from the calling party.

In one embodiment of the present invention, the alternate destination can include an email address. In this embodiment, the calling party can leave a message which is then either converted to text or an audio file and then forwarded to the called party's email address. In the case of an audio file, the file, such as a WAV or MP3 file can be sent embedded in the email or, a link for downloading or streaming the audio file can be sent in the email message.

In another embodiment, the dialing sequence may include one of a plurality of special calling codes. In such an embodiment, the alternate destination may be selected based on which special calling code is included in the sequence. As a non-limiting example, if the special calling code is a first value, then the alternate address of the called party is voice mail, and if the special calling sequence is a second value, then the alternate address of the called party is the called party's cellular telephone and if the special calling sequence is a third value, then the alternate address of the called party is an email address.

These and other embodiments, aspects and features of the present invention are further described in conjunction with the figures and detailed description.

### BRIEF DESCRIPTION OF THE SEVERAL VIEWS OF THE DRAWING

FIG. 1 is a flow diagram illustrating steps included in an exemplary embodiment of the present invention.

FIG. 2 is a flow chart illustrating the operation of an embodiment of the present invention from the calling party's and the called party's perspective.

FIG. 3 is a block diagram illustrating an exemplary environment suitable for various embodiments of the present invention.

### DETAILED DESCRIPTION OF EMBODIMENTS OF THE INVENTION

The present invention, as well as features and aspects thereof, is directed towards providing a technique for a calling party to directly access a called party's voice mail for the purposes of leaving a message. More particular, embodiments of the present invention include the dialing of a special prefix that signals operates to signal the public switched telephone network that the presently dialed call is to be subject to special routing. For instance, in one embodiment of the present invention, a calling party can call a predefined prefix, and then dial a called party's 10 digit telephone number. When the switching system or central office receives the dialed sequence, it searches for the prefix. If the prefix is detected, the system knows that the calling party wishes to be immediately directed, transferred, forwarded or terminated with the called party's voice mail system. In another embodiment of the present invention, rather than a prefix, a suffix may be used to signal to the PSTN that the call is to be routed to a recipients voice mail. In yet another embodiment of the invention, rather than being routed to voice mail, the special dialing sequence may result in triggering the message to be sent to the called party's email address, sent as an SMS message, or some other delivery mechanism in which a voice message can be delivered as an audio file, a text file generated from the audio, or as a link to a downloadable message.

Turning now to the figures in which like elements are represented by similar labels, the various aspects, features and embodiments of the present invention are presented in more detail.

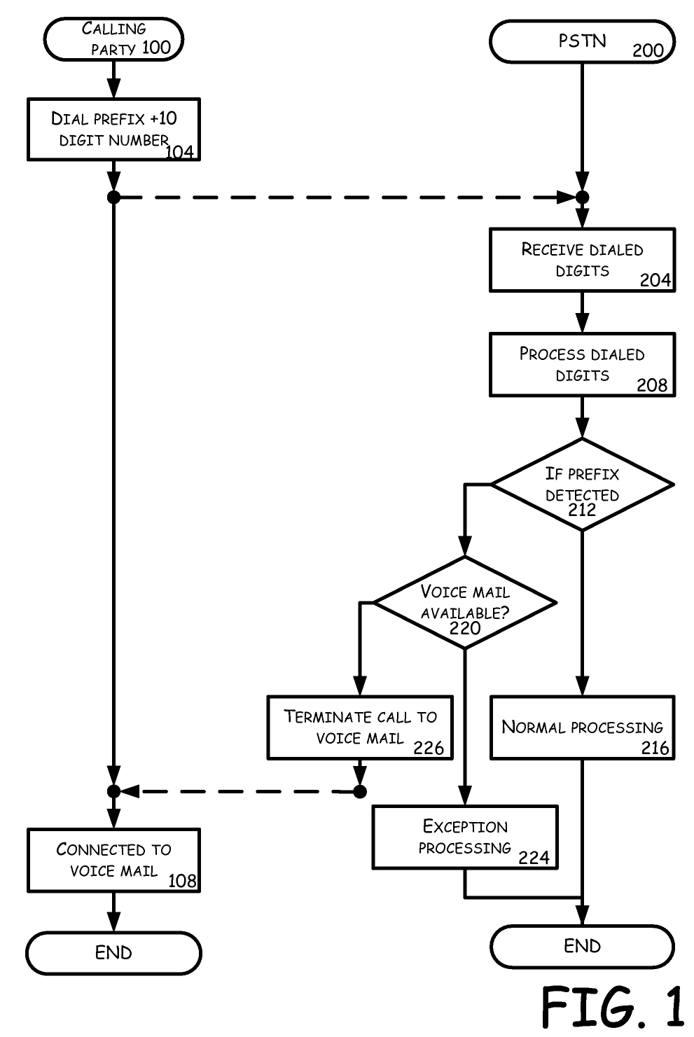

FIG. 1 is a flow diagram illustrating steps included in an exemplary embodiment of the present invention. FIG. 1 shows an embodiment of the present invention from two perspectives, the view of the calling party 100 and the view of the PSTN 200. It should be appreciated that although the present invention is described as operating within the PSTN, that other similar network types may also be suitable environments for the present invention. For instance, the present invention could be implemented within a cellular telephone system, such as by modifying the MTSO, or in a private telephone network. In addition, the present invention could be implemented in a voice over IP system (VOIP).

The illustrated embodiment operates first by a calling party 100 dialing a prefix and a 10 digit number. As previously mentioned, this is simply one embodiment of the invention. Other embodiments may utilize a suffix. In addition, the process of dialing is not limited to pressing buttons on a telephone device but rather, may include recalling a number from memory and selecting that number, or having a computer or processing unit dial or send the desired prefix and 10 digit number.

The dialed prefix and 10 digit number then propagates to the PSTN, such as a switching office (SO) where the numbers are received 204. The received data is then analyzed, processed and/or interpreted for call setup and routing 208. If the SO does not detect that the received data includes the special prefix 212, then normal processing is performed with the received data 216. However, if the received dialing information does include the prefix 212, then the SO or other processing entity can determine if the intended recipient identified by the 10 digit number has a voice mail account 220.

In should be appreciated that although this functionality is being described as embedded within the PSTN or an SO, the present invention can actually be implemented in a variety of settings such as a PBX or other system. For instance, rather than the SO determining if the intended recipient has a voice mail service, the SO could simply recognize the prefix as a special dialing sequence and route the call with a flag set or with the prefix still included to the system terminating the dialed number. If such a system is a PBX, the PBX may simply route the call directly to the subscriber's voice mail, if available.

If at step 220, the SO determines that the intended recipient does not have voice mail available, exception processing can be performed 224, which may be limited to or include simply performing normal processing 216. However, if the SO determines that the intended recipient does have voice mail 220, the call is routed to the voice mail system of the intended recipient 226.

From the calling party's perspective, the call is directly connected to the called party's voice mail as though the call was either transferred voice mail by the called party or the receiving system. Advantageously, the called party is not notified at the time of the call reception by the sounding of the normal alert mechanisms—such as sounding the alarm or ring tone.

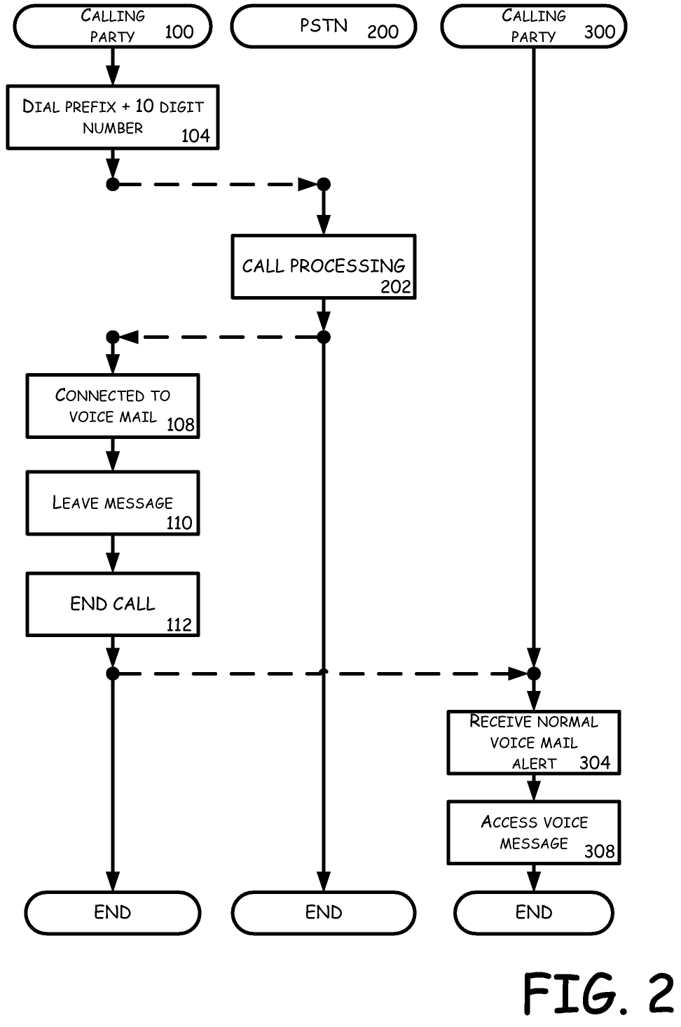

FIG. 1 does not illustrate the operation of the system from the called party's perspective. FIG. 2 is a flow chart illustrating the operation of an embodiment of the present invention from the calling party's and the called party's perspective. In FIG. 2, the calling party 100 dials the prefix and the 10 digit number 104 as illustrated in FIG. 1 and the PSTN 200 processing the call 202 similar to what was illustrated in FIG. 1. Once the calling party is connected to the called party's voice mail 108, the calling party can leave a message 110 and/or select other options. When the calling party 100 is done, the calling party 100 ends the call 112. Up to this point, the called party 300 is completely unaware of the calling activity. However, once the calling party 100 is completed, the PSTN or other system implementing this aspect of the invention, can notify the called party 300 using normal voice mail alerting procedures 304. For instance, if the calling party 300 is normally notified of a voice message by activating an icon or a flashing LED on the called party's handset, then the present invention can operation to provide such notice. In response to the alert and at timing selected by the called party 300, the voice message can then be retrieved for playback.

It should be appreciated that in various embodiments of the present invention, that alternative alert means can be selected for messages that are delivered through the direct dial to voice mail embodiments. For instance, a special tone or icon for this particular message type can be sounded. In addition, the called party 300 and/or the calling party 100 may have the ability to select delivery mechanisms in various embodiments of the invention. For instance, in one embodiment, components within the PSTN may operate to present delivery options to the calling party 100. As a non-limiting example, the calling party may be presented with a prompt, either before or after leaving a message, to select the type of delivery. The delivery options may include standard voice mail, email delivery with an attached audio file such as a WAV file or MP3 file, an SMS, text message or email including a link to an audio file, a text message such as SMS, text or email that contains a voice to text conversion of the message, a facsimile transmission of a voice to text conversion of the message, or the like. Alternatively, or in addition to, the called party may also have the ability to select delivery options including any of the above listed options or others. Finally, the called party 300 can then access the voice message 308 at a convenient time.

In a particular embodiment, the prefix to route calls to a subscribes voice mail is the digit 2. Thus, the calling party would enter 2 and the 10 digit telephone number of a voice mail subscriber. The applicable telecommunications network would detect the 11 digit number with a prefix of 2 and recognize the number as a direct to voice mail dialing. The telecommunications network can then directly route the call to the voice mail box of the subscriber identified or associated with the 20 digit telephone number or address.

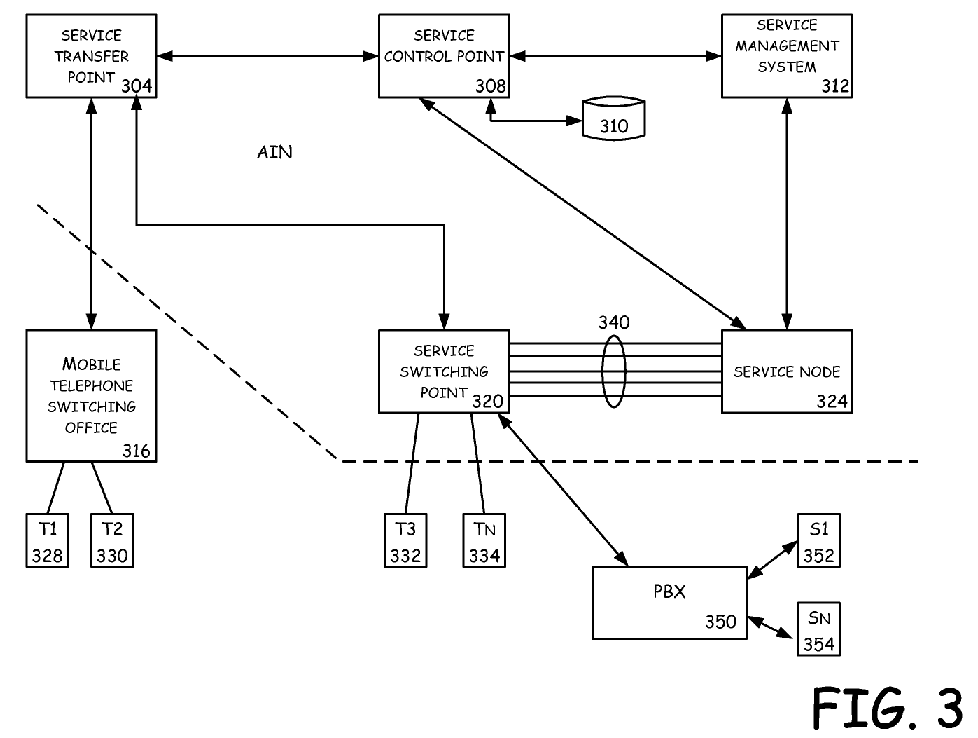

FIG. 3 is a block diagram illustrating an exemplary environment suitable for various embodiments of the present invention. The illustrated environment includes a portion of a public switched telecommunications network (not shown) including an Advanced Intelligent Network (“AIN”) of a typical local exchange carrier (“LEC”). The AIN is well known to those skilled in the art and includes a plurality of central office switches with some of the central office switches equipped with service switching points (“SSPs”). An SSP (e.g., a 5ESS, DMS, or 1AESS type central office switch) is the AIN component of a typical electronic central office switch used by a local exchange carrier. The terms “SSP” and “switch” are used interchangeably to refer to a telecommunications switch for connecting voice channel circuits, including voice channel lines such as the lines going to terminals T3 332 and TN 334.

Each SSP in the AIN serves as an originating switch for a number of subscriber lines. Generally, an originating switch is directly connected with the subscriber lines serviced by the switch. Thus, the originating switch that services a subscriber's line is usually the first network element of the AIN to process communications originating on the subscriber's line. The originating switch receives a communication originating on the subscriber line and implements further processing, such as routing the communication for connection with a terminating destination. For example, an SSP 320 may receive a communication from an originating station, such as telephone device T3 332, on a subscriber line and route the communication for connection with a terminating destination TN 334 in accordance with the packet-switched protocol of the PSTN. The details of communication routing are familiar to those skilled in the art.

The switches of the AIN are interconnected by a network of voice channel lines known as trunks. Trunks are the voice channel circuits that interconnect the central office switches to connect voice-channel communications. The term “communication” includes all messages or communications that may be exchanged between two pieces of terminating equipment. In FIG. 3, the terminating equipment is represented by telephones that are commonly designated as 7 and 8. Although the terminating equipment is illustrated as telephones, those skilled in the art will understand that terminating equipment may include other communication devices, such as wireless telephones T1 328 and T2 330 accessed through an mobile telephone switching office 316, facsimile machines, computers, modems, etc.

Each piece of terminating equipment in the PSTN is preferably assigned a directory number. The term “directory number” is used herein in a manner consistent with its generally understood meaning of a number that is dialed or input by a calling party at an originating station to reach a terminating destination associated with the directory number. A directory number, typically a seven or ten-digit number, is commonly referred to as a “telephone number” and may be assigned to a specific telephone line.

It should also be noted that FIG. 1 illustrates a conventional landline telecommunications system, in which each subscriber is associated with a unique subscriber line as well as a wireless telephone system in which subscribers access the PSTN through a mobile telephone switching office 316. Various embodiments of the present invention may operate in both structures.

Routing a communication from the originating station to the terminating destination involves the selection of a routing path for the communication and may also involve the implementation of one or more advanced network functions. The ability of a typical SSP to provide these advanced network functions, however, is limited due to physical and other constraints. The AIN therefore provides for increased information processing capability through a system of intelligent network elements that are functionally connected with the SSPs through a network of data links.

These intelligent network elements of the AIN can communicate with each other, and with the SSPs of the network, via digital data messages transmitted over the network of digital data links. An SSP may be configured to interface with these intelligent network elements through the use of a “trigger.” In general, a trigger serves as an indicator for the SSP to take certain action. The SSP is configured so that, when the SSP detects a predetermined set of conditions defining the trigger in association with a communication, the SSP creates an appropriate digital data message for transmission over the network of digital data links. The SSP may also suspend routing of the communication (i.e., hold the communication) until the SSP receives a reply to its message from an appropriate network element (via the network of digital data links) instructing the SSP to take a certain action. If the SSP receives no instructions within a certain amount of time, the SSP may “time-out” and execute a default task for the communication.

The message created by an SSP in response to a trigger is known as a “query” message. A query message opens a “transaction” and the SSP generally holds the communication while the transaction remains open. The reply to the query message may be a “conversation” message or a “response” message. Conversation messages allow for bi-directional exchanges between network elements while the transaction remains open. A “response” message closes the transaction opened by the query message, and usually instructs the SSP to route the held communication for connection with a terminating destination. A trigger is typically activated or deactivated at an SSP by another network element through an “update” message. Query messages, conversation messages, response messages, and update messages are standard types of messages defined by the AIN protocol. The details of the AIN protocol are well known to those skilled in the art.

In an exemplary embodiment of the present invention, the originating switch 320 is an SSP. It is noted, however, that the AIN may also include non-SSP central office switches (not shown). It will be appreciated that a non-SSP switch may initially receive a communication on a subscriber line and pass the communication to another switch, such as SSP 320, for further processing. Similarly, in a cellular or wireless network, a mobile telecommunications switching office (“MTSO”) or other receiver/transmitter may initially receive a communication from a cellular telephone or wireless unit and route the communication to another network element, such as SSP 320, for further processing. In this manner, advanced network functions available through the AIN may be provided to wireless units and to subscriber lines that are directly connected to non-SSP switches.

Each switch in the AIN is connected to a signal transfer point 304 via a data link. The signal transfer point 304 is a multi-port, high-speed packet switch that is programmed to respond to the routing information in the SS7 protocol and route the packet to its destination. Digital data messages flowing between the service control point 308 and the SSP 320 go through signal transfer point 304. Thus, the signal transfer point 304 is not normally the destination of a message, but merely directs traffic among the other entities on the network that generate and respond to the data messages.

Much of the intelligence of the AIN resides in a one or more service control points 308 which are connected to the signal transfer point 304 by an SS7 data link. A service control point 308 is a remotely programmable intelligent network element. As is known to those skilled in the art, a service control point is physically implemented by relatively powerful fault tolerant computers. Among the functions performed by a service control point is the maintenance of network databases, such as database 310, which is used in providing subscribers with advanced network functions.

Additional devices for implementing advanced network functions within the AIN are provided by a service management system 312. The service management system 312 is connected via a data link to the service control point 308. The service management system 312 provides a centralized platform for remotely programming the service control point 308 so that a coordinated information-processing scheme may be implemented for the AIN. The service management system 312 is implemented by a large general-purpose computer and interfaces to business offices of the local exchange carrier and inter-exchange carriers. The functions of the service management system 312 include: (a) downloading information to the database 310 when new subscribers are added or when subscribers modify their ensemble of services; (b) performing data reloads when the service control point 308 crashes or when software needs to be updated; (c) implementing high volume routing services, such as call forwarding and 800 number translation and routing; (d) maintaining and providing access to high volume databases for the authorization of billing, such as credit card number validations; and (e) downloading, on a non-real-time basis, billing information that is needed in order to appropriately invoice telephone company subscribers for the services provided.

As illustrated in FIG. 3, the AIN also includes a service node 324, which may also be referred to as a service circuit node. The service node 320 includes voice and dual tone multi-frequency (“DTMF”) signal recognition devices and voice synthesis devices. The service node 320 communicates with the service control point 308 via a data link using X.25 or TCP/IP protocols, and to the service management system 312 via a another data link. In addition, the service node 320 typically is connected to one or more (but usually only a few) SSPs via Integrated Service Digital Network (“ISDN”) links, as shown by the connection 340 to the service switching point 320.

The AIN thus provides subscribers with a selectable menu of advanced network functions. These advanced network functions are typically sold on a per-service basis, or in groups of services known as calling plans. Each subscriber may select a set of advanced network functions, or a calling plan that suits the subscriber's needs. Moreover, each subscriber may generally select among a plurality of local advanced network functions, as well as select among a plurality of long distance advanced network functions.

Cellular, wireless digital or mobile communication networks are similarly situated to provide intelligent features similar to what are available through the AIN or, in conjunction with components of the AIN. In addition, a PBX 350 connected to the telecommunications network such as through a service switching point 320 or even an MTSO or other point of entry may also operate to provide some or all aspects of an embodiment of the present invention while servicing stations S1 352 and SN 354.

Those familiar with such telecommunication systems as the AIN and mobile networks will appreciate that services such as those described for the various embodiments of the present invention can be implemented to detect the sequence of dialed digits and then redirect the call upon detection of a particular prefix or suffix.

Thus, as described one embodiment of the invention includes directing a call to a recipient's voice mail box by including a 2 as a prefix to the recipients normally dialed telephone number. The various telecommunications systems can detect the prefix and route the call directly to voice mail if available.

It should be appreciated that embodiments of the present invention that allow a caller to directly access a calling party's voice mail do not negate all of the other voice mail related features. For instance, if a voice mail system provides an email notification of a received voice message to the subscriber, the voice mail system can still operate to provide such notice. Thus, the present invention operates as though the calling party was actually put through to the called destination and then rolled over to voice mail. An advantage of the present invention is that the called party does not have to be disturbed and the calling party does not have to wait through the entire process of unanswered rings, and rolling over to voice mail.

However, other embodiments of the invention can include a series of prefixes that can be used to direct the call to a variety of locations. Those skilled in the art are familiar with the traditional model of calling a universal number and then being prompted to select a forwarding or routing destination for the call. This embodiment of the present invention actually operates to direct calls to various locations without having to interact with a menu structure or voice interface. For instance, similar to traditional routing or forwarding features, a subscriber can enter a list of PSTN destinations or other message delivery destinations such as voice mail boxes, email, SMS's etc. Each of these destinations can be associated with a particular prefix. For instance, the prefix “2” could be used to identify voice mail, “3” email, “4” a home number and “5” a mobile number. In operation, a calling party can determine where he or she wants to attempt to contact the subscriber, enter that prefix followed by the 10 digit number for the subscriber. The telecommunications network then detects the prefix and the 10 digit number, accesses a database to determine where the call is to be routed, and then performs the operation. Advantageously, this aspect of the invention allows a party to try to contact a subscriber at various locations by giving the calling party direct calling access without having to navigate a menu and, by using the subscribers same 10 digit so that the calling party does not have to memorize multiple numbers for the subscriber.

In another embodiment, the prefixes can be system selected and when a subscriber registers for the service, he or she provides the numbers or routing destinations to the service provider. In such an embodiment, one prefix can always be used to direct a call to voice mail, another prefix may always be used to direct the call to the subscribers main office number, and another prefix may be used to invoke an email delivery of an audio file or a link of the message, etc.

Embodiments of the present invention may also be suitable for video calls. Similar to voice calls, the telecommunications network can detect a dialed prefix or suffix and automatically route the call to an alternate destination, such as video voice mail rather than disturbing the intended recipient.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method for providing direct dialing access to an alternate destination of a called party, the method comprising the steps of:
receiving a dialed sequence associated with a call setup request from a calling party device;
parsing the dialed sequence;
detecting a special calling code in the dialed sequence;
detecting a destination number in the dialed sequence; and
establishing a communication session between the calling party device and an alternate destination associated with the destination number.

2. The method of claim 1, wherein the step of establishing a communication session between the calling party device and an alternate destination is performed without requiring any additional information from the calling party.

3. The method of claim 2, wherein the step of establishing a communication session between the calling party device and an alternate destination further comprises the step of selecting an alternate destination based on the detected special calling code.

4. The method of claim 2, wherein the alternate destination is the voice mail of the called party and the step of detecting a special calling code in the dialed sequence further comprises detecting a prefix of one or more numbers preceding a ten-digit destination number.

5. The method of claim 2, wherein the alternate destination is an email address and the step of establishing a communication session between the calling party device and the alternate destination associated with the destination number comprises directing an email to the email address and providing access to the voice message through the email.

6. The method of claim 5, wherein the step of providing access to the voice message through the email comprises attaching an audio file to the email.

7. The method of claim 5, wherein the step of providing access to the voice message through the email comprises embedding a link to the voice message.

8. The method of claim 2, wherein the dialing sequence may include one of a plurality of special calling codes and the step of establishing a communication session between the calling party device and an alternate destination further comprises the step of selecting an alternate destination based on the detected special calling code and connecting the calling party device to the alternate destination.

9. The method of claim 8, wherein if the special calling sequence is the prefix 2, then the alternate address of the called party is voice mail.

10. The method of claim 8, wherein if the special calling sequence is a first value, then the alternate address of the called party is voice mail, and if the special calling sequence is a second value, then the alternate address of the called party is the called party's cellular telephone and if the special calling sequence is a third value, then the alternate address of the called party is an email address.

11. A method for directing communications intended for a particular party, the communications include a particular telephone number that is associated with the particular party, the method comprising the steps of:
receiving a sequence for initiating a communication;
parsing the sequence;
detecting a special code in the received sequence;
detecting a particular telephone number in the received sequence; and
directing a communication associated with the received sequence to a destination that is selected based on the special code and the particular telephone number.

12. The method of claim 11, wherein the step of directing a communication associated with the received sequence further comprises directing the communication to a voice mail system serving the particular party.

13. The method of claim 11, wherein the special code is a dialed digit prefix to the particular telephone number and the step of parsing the sequence further comprises verifying that the sequence includes 11 dialed digits and the step of detecting a special code in the received sequence further comprises examining the first digit of the 11 dialed digits to determine if it is the dialed digit prefix.

14. The method of claim 11, wherein the special code is a dialed digit prefix to the particular telephone number and the step of parsing the sequence further comprises verifying that the sequence includes 12 dialed digits and the step of detecting a special code in the received sequence further comprises examining the first two digits of the 12 dialed digits to determine if it is the dialed digit prefix.

15. The method of claim 11, wherein the special code is a dialed digit prefix to the particular telephone number and the step of parsing the sequence further comprises verifying that the sequence includes 13 dialed digits and the step of detecting a special code in the received sequence further comprises examining the first three digits of the 13 dialed digits to determine if it is the dialed digit prefix.

16. The method of claim 11, wherein the special code is a dialed digit prefix to the particular telephone number and the step of parsing the sequence further comprises verifying that the sequence includes 10+n dialed digits and the step of detecting a special code in the received sequence further comprises examining the first n digits of the 10+n dialed digits to determine if it is the dialed digit prefix.

17. A method for providing direct dialing access to one or more alternate destinations of a called party, the method comprising the steps of:
receiving a dialed sequence associated with a call setup request from a calling party device;
parsing the dialed sequence;
detecting a special calling code in the dialed sequence;
detecting a destination number in the dialed sequence;
selecting an alternate destination based on the special calling code and the destination number; and
establishing a communication session between the calling party device and the alternate destination associated.

18. The method of claim 17, wherein the step of selecting an alternate destination based on the special calling code further comprises selecting a voice mail destination if the special calling code is equal to a first value.

19. The method of claim 17, wherein the particular number is a cellular telephone number and the step of selecting an alternate destination based on the special calling code further comprises selecting a voice mail destination if the special calling code is equal to a first value.

20. The method of claim 19, wherein step of selecting an alternate destination based on the special calling code further comprises selecting a telephone number provided by the called party if the special calling code is equal to a second value.
